(19) United States
(12) Patent Application Publication
(10) Pub. No.: US 2014/0139146 A1
(43) Pub. Date: May 22, 2014

(54) LOW VOLTAGE LIGHTING SYSTEM FOR NEW CONSTRUCTION APPLICATIONS

(71) Applicants: Daniel A. Lax, New York, NY (US); Agjah I. Libohova, Westbury, NY (US); William Miller, Huntington, NY (US)

(72) Inventors: Daniel A. Lax, New York, NY (US); Agjah I. Libohova, Westbury, NY (US); William Miller, Huntington, NY (US)

(21) Appl. No.: 14/080,761

(22) Filed: Nov. 14, 2013

Related U.S. Application Data
(60) Provisional application No. 61/726,380, filed on Nov. 14, 2012.

(51) Int. Cl. F21V 33/00

(52) U.S. Cl. CPC F21V 33/006
USPC 315/363; 362/145

(57) ABSTRACT

A lighting system for new construction and a method for installing a lighting system in a component construction system such as a concrete slab construction system are disclosed. Lighting units are built into the construction components to provide electrical power that may be low voltage electrical power used by LED light engines. The power can be used by temporary task lighting or the lighting units to be used in the finished building. The disclosure provides the lighting units, the lighting units combined with the construction elements, methods of making the combined unit and construction elements, and methods for using the lighting units.

### CROSS REFERENCE TO RELATED APPLICATIONS

This application claims the benefit of U.S. Provisional Patent Application Ser. No. 61/726,380 filed Nov. 14, 2012; the disclosures of which are incorporated herein by reference.

### BACKGROUND OF THE DISCLOSURE

1. Technical Field

This disclosure generally relates to lighting systems used during new construction and, more particularly, to a low voltage lighting system built into concrete slabs during new construction so the wiring is readily available to the finish workers after the structure is built.

2. Background Information

Concrete is one of the most common building materials used to fabricate structures used by humans such as multiple story office and residential buildings. Concrete slab construction is a construction methodology that uses concrete slabs as various structural parts of the building. The concrete slabs may be horizontal ceilings and floors, ground pads, and/or vertical walls. The slabs may be supported by concrete or steel framing. The slabs may be steel-reinforced. The slabs may be preformed off site or poured on site. The size and shape of the slabs varies based on the application. Although the slabs are generally rectangular, they do not necessarily have six smooth, flat surfaces. The particular configuration of a slab depends on its application and the structural requirements for its location. As such, a slab may not have a lower-facing surface that is entirely flat and smooth. For example, structural slabs may be ribbed, I-beam-shaped, or waffle-shaped to provide structural strength.

Constructing a new building generally requires the structural components of the building to be installed to form a shell. The various finish steps are then performed inside and around the structural components. When work is performed inside the structure, the workers require lighting. Providing temporary task lighting for contractors working on job sites is an expensive and time consuming requirement. Today's typical solution requires an electrician to run stringers of 110V wire on the underside of the concrete slabs to the center of each room that is to be lighted. Temporary light fixtures are installed at these locations to provide light to the workers. This system adds expense to a project because it must be installed by electricians and then powered by 110 V electrical power during the length of the project. Another drawback with this system is that the light supplied to the workers is limited in location and power.

### SUMMARY OF THE DISCLOSURE

The disclosure provides a lighting system for new construction and a method for installing a lighting system in a component construction system such as a concrete slab construction system.

The disclosure provides lighting units that are built into the construction components to provide electrical power. The power can be used by temporary task lighting or the lighting units to be used in the finished building.

The disclosure provides the lighting units, the lighting units combined with the construction elements, methods of making the combined unit and construction elements, and methods for using the lighting units.

### BRIEF DESCRIPTION OF THE DRAWINGS

FIG. 1 is a perspective view of one unit of the lighting system before it is built into a construction slab.

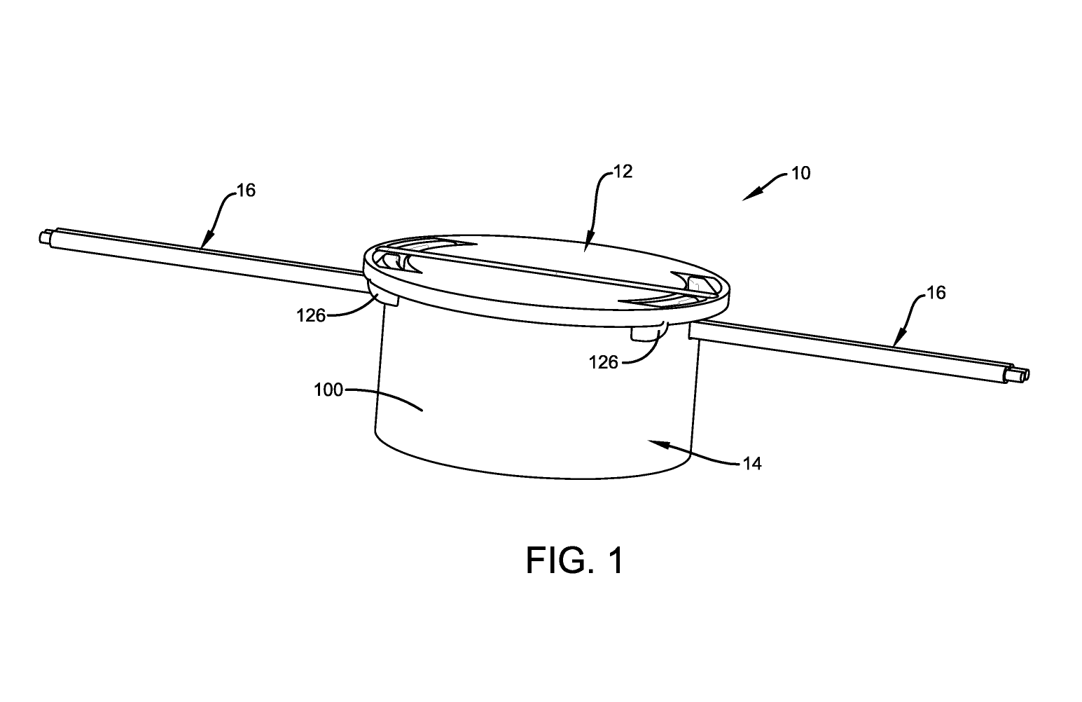

FIG. 2 is a perspective view similar to FIG. 1 with the cap detached from the body.

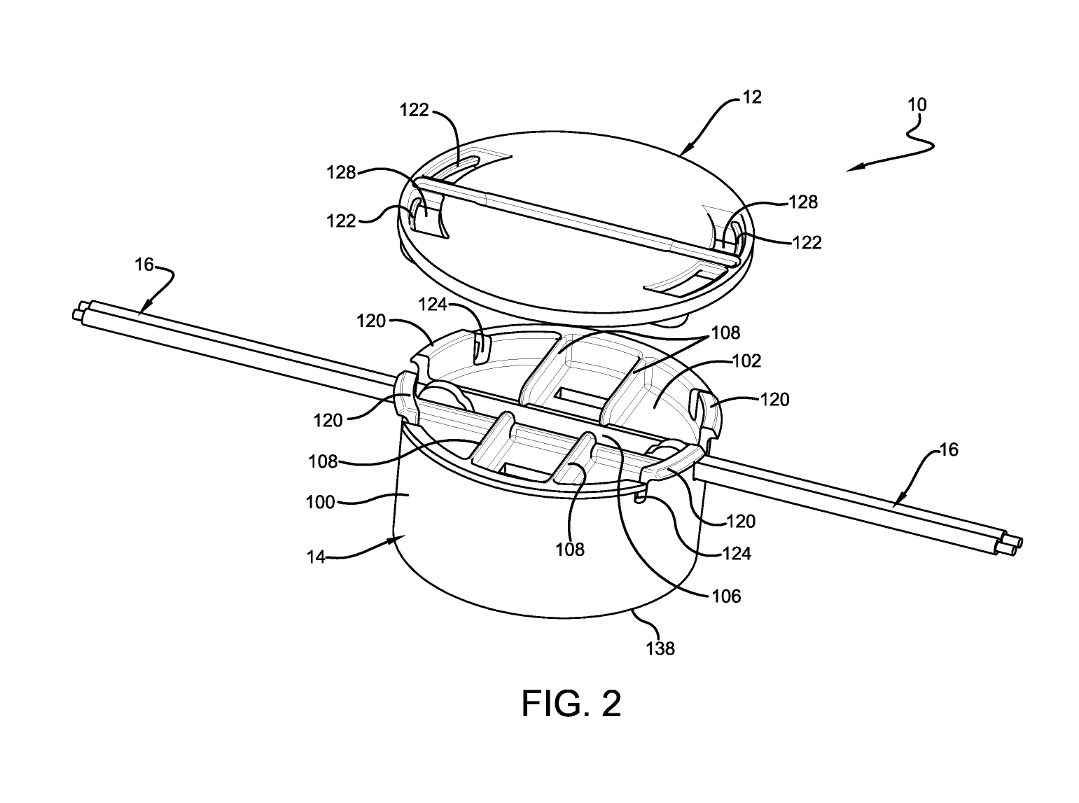

FIG. 3 is an exploded view of the unit.

FIG. 4 is an exploded view of the unit disposed above a section of the form used to fabricate the concrete slab.

FIG. 5 is a perspective view of the mounting plate secured to the form with a pair of connectors.

FIG. 6 is a perspective view of the body connected to the mounting plate.

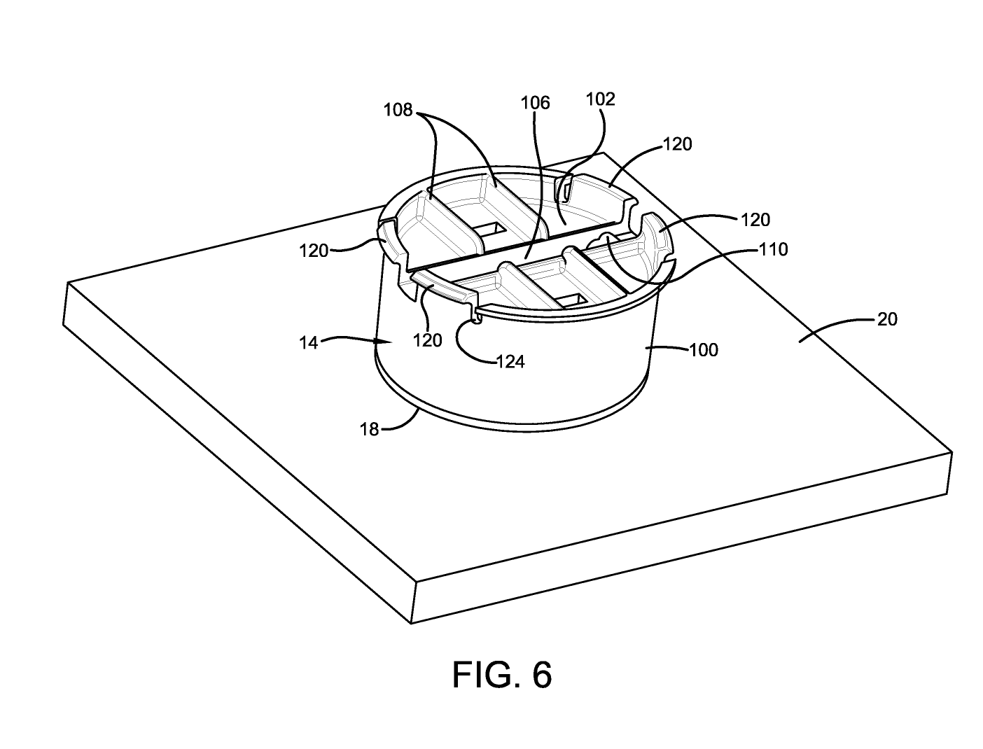

FIG. 7 is a perspective view of a section of low voltage wire being placed into the body of the unit.

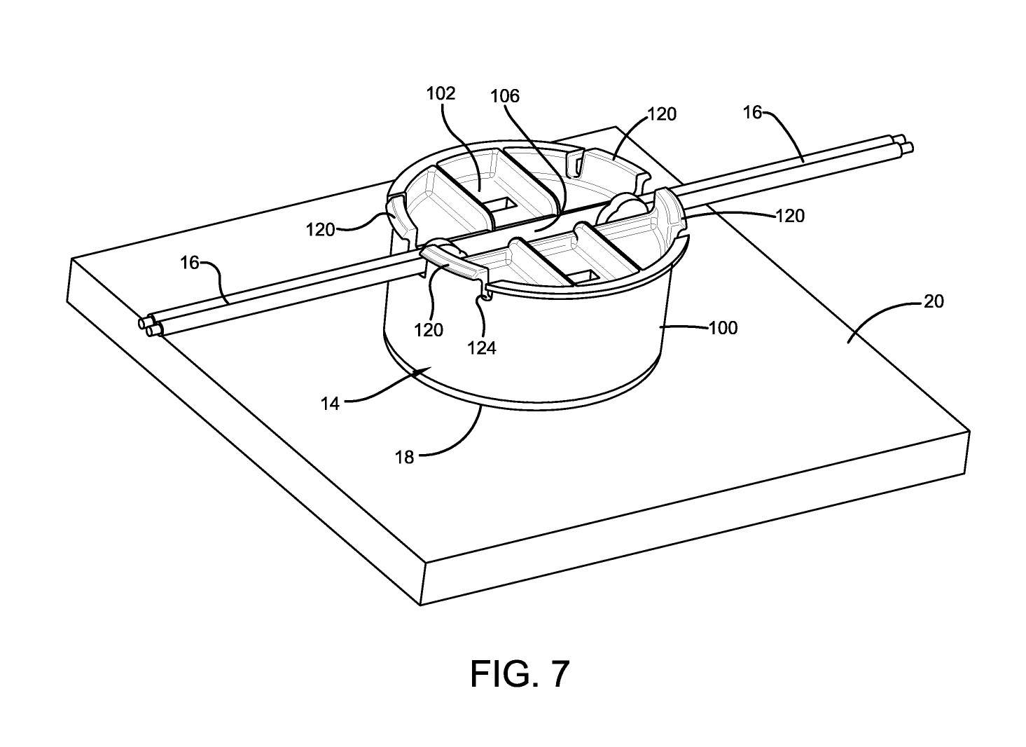

FIG. 8 is a perspective view of the unit with the cap installed over the low voltage wire.

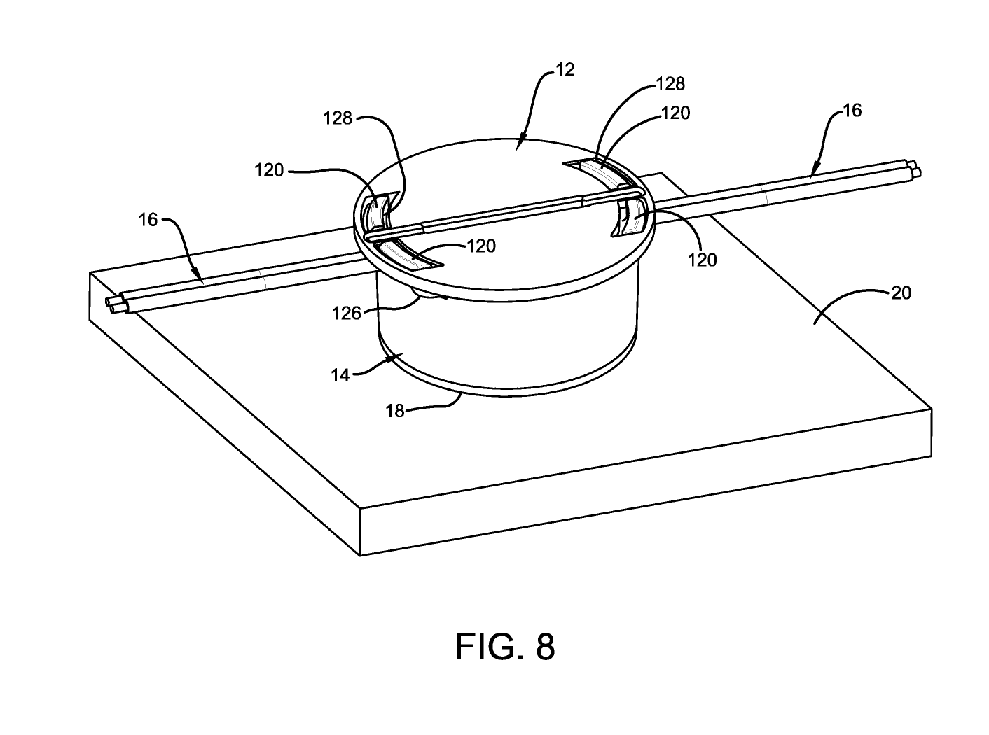

FIG. 9 is a perspective view representing the pouring of the concrete slab around the unit that is still attached to the form.

FIG. 10 is a perspective view of the bottom of the slab shown in FIG. 9 with the section of the form removed to expose the mounting plate.

FIG. 11 is a perspective view of the end of the slab showing the mounting plate being removed from the body of the unit to expose the portion of the low voltage wiring disposed in the body of the unit.

FIG. 12 is a perspective view looking up into the body of the unit showing the low voltage wire.

FIG. 13 is a perspective view of the bottom of the slab with a cover placed on the body of the unit to allow the unit to be taken out of service and covered for the final finishing of the room.

FIG. 14 is a schematic of the slab with a light and a power supply.

Similar numbers refer to similar parts throughout the specification.

### DETAILED DESCRIPTION OF THE DISCLOSURE

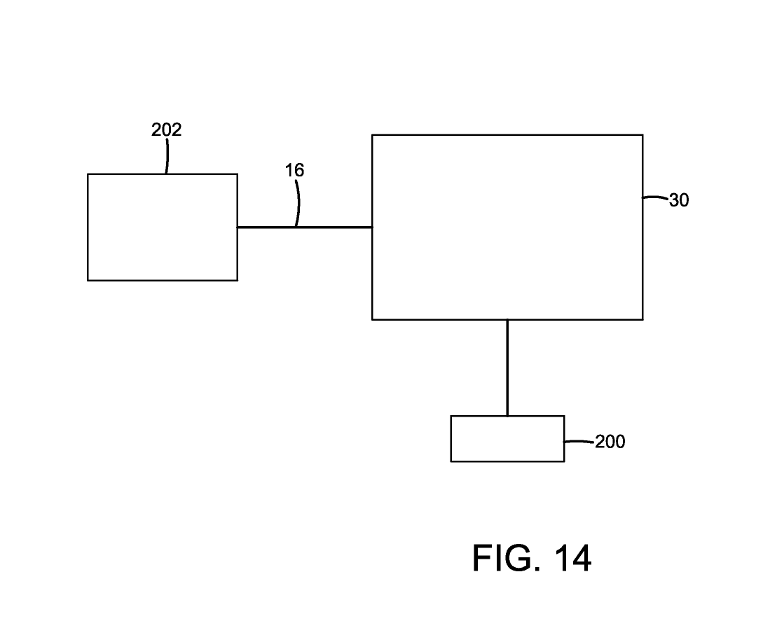

An exemplary unit for supplying power to a light (such as a low-voltage powered LED light engine) is indicated generally by the reference numeral 10 in the accompanying drawings. Unit 10 is used to provide low voltage power to a light (shown in FIG. 14) such as an LED light engine 200 that will provide task lighting during the finishing of a construction project. When the construction project is completed or when the task lighting is no longer needed, units 10 may be disconnected and covered over and left in the structure. In other configurations, units 10 may be used to power low-voltage powered lighting in the structure. At least one, but typically a plurality of units 10 are used together to define a low voltage power distribution system that is built into the components of a component construction system so that low voltage lighting (such as LED lighting engines) may be installed and powered during the construction project. In the example of the system described here, the component construction system is a concrete slab construction system wherein concrete slabs are fabricated in forms. The slabs may be formed in place or off site. The system may be used regardless of where the slab is formed. The system also may be used with other component construction systems wherein the components are created in forms or molds.

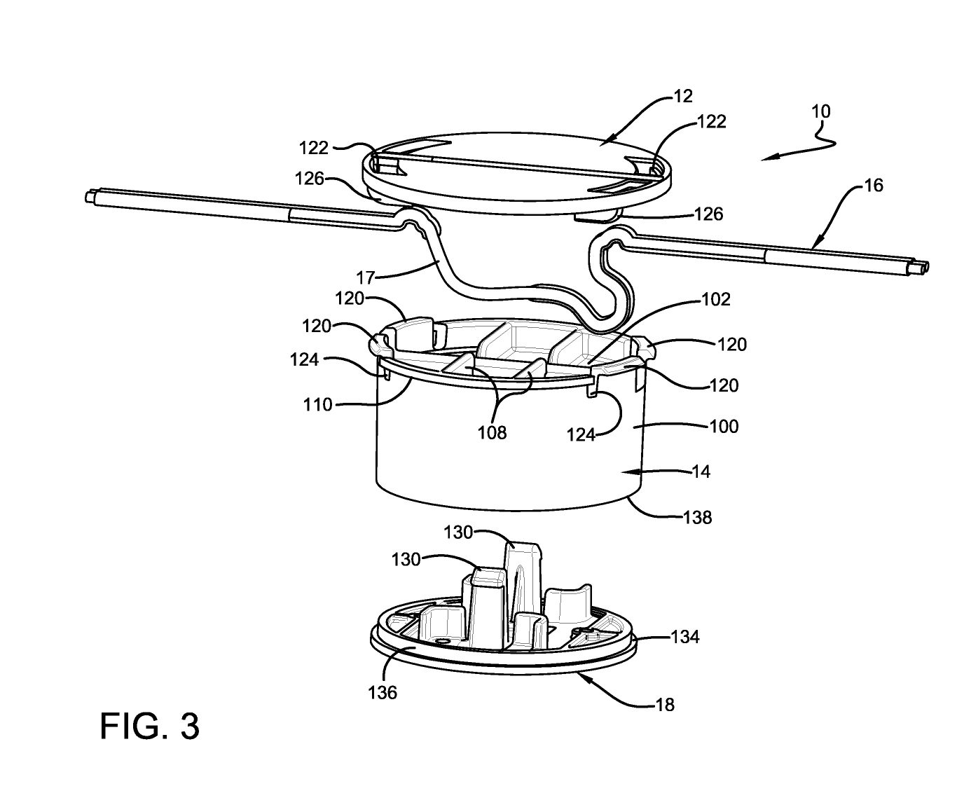

Unit 10 generally includes a cap 12 that is fit onto a body 14 to secure a section of low voltage wire 16 within body 14. Wire 16 is fit inside body 14 with a slackened portion such as the half loop 17 of wire 16 depicted in FIG. 3. This portion of wire 16 is used to supply power to a light fixture (such as light 200 shown in FIG. 14) that is connected after the slab is installed and the workers require task lighting. Wire 16 is run through the slab and out of a portion of the slab (usually an end wall or sidewall of the slab) so that wire 16 may be connected to a low voltage power supply 202 (shown in FIG. 14) after the slab is installed. Wire 16 may be connected directly to a low voltage power supply or to a low voltage bus line. A plurality of units 10 may be installed in a single slab and no single unit 10 must be positioned at the eventual position of a light in the final structure because units 10 may be covered and discarded when the workers are finished with them. A plurality of bodies 14 may be installed on a single low voltage wire 16 or multiple wires 16 may be used. The portion of low voltage wire 16 disposed inside body 14 is configured to power LED lighting engine that are later connected to wire 16 with quick-connect clips or electrical splices.

Body 14 has a sidewall 100 and a top wall 102 that cooperate to define a cavity 104 that receives the portion of wire 16 that will be used to support the electrical connection between wire 16 and the LED lighting engine. Body 14 may be provided in a wide variety of shapes and sizes. Top wall 102 defines a slot 106 through which wire 16 is pushed into cavity 104. Top wall 102 defines a plurality of ribs 108 which strengthen body 14 and support cap 12. Top wall 102 also defines a pair of wire clamp ribs 110 over which wire 16 is disposed to hold wire 16 in place when cap 12 is attached to body 14. Sidewall 100 defines a plurality of locking fingers 120 configured to lock cap 12 to body 14 in a secure manner. Locking fingers 120 engage locking surfaces 122 defined by cap 12 in a secure connection. The connection between fingers 120 and locking surfaces 122 may be a one-way locking snap fit connection because cap 12 does not need to be removed after wire 16 is installed. The position of locking fingers 120 and locking surfaces 122 may be reversed such that locking fingers 120 may be carried by cap 12 and locking surfaces 122 may be defined by body 14. Sidewall 100 defines notches 124 adjacent fingers 120 and cap 12 includes alignment ribs 126 that fit into these notches 124 to align cap 12 and to close openings in sidewall 100 to prevent or limit the ingress of concrete during the formation of the slab in which body 14 and cap 12 are installed. Cap 12 defines openings 128 that receive the tips of locking fingers 120 when cap 12 is installed. Openings 128 and locking fingers 120 are configured to cooperate to substantially close off openings 128 in cap 12 to prevent or limit the ingress of concrete when body 14 and cap 12 are built into the slab. Cap 12 includes a pair of wire clamps (not shown) that engage wire 16 above wire clap ribs 110 to retain the position of wire 16 with body 14 and cap 12 when cap 12 is locked to body 14.

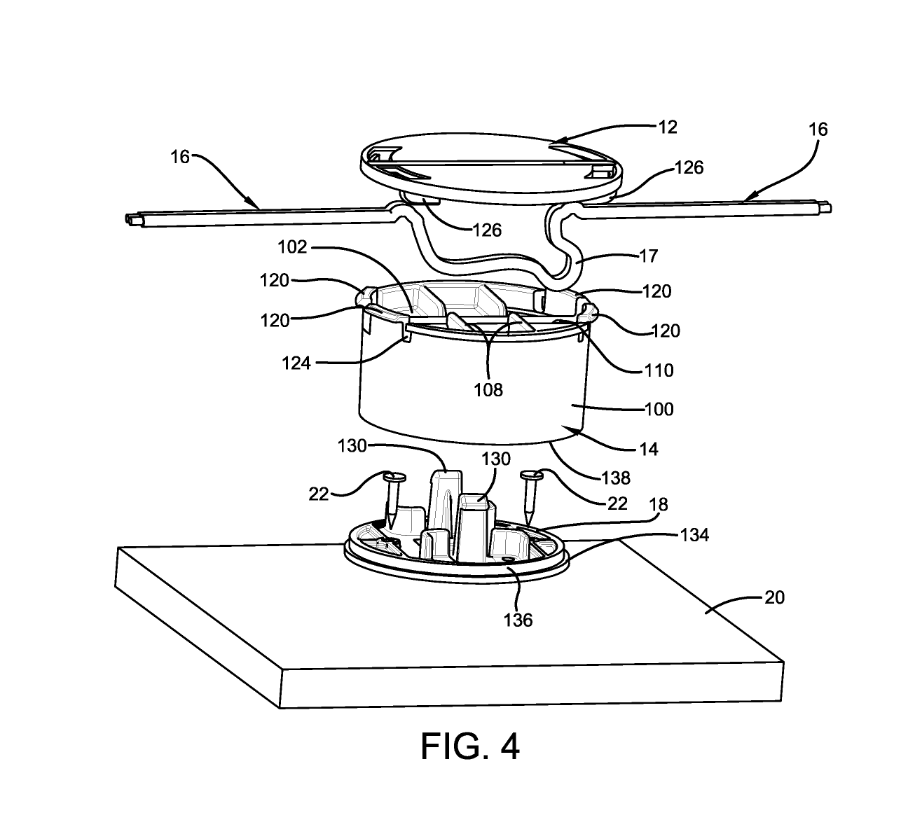

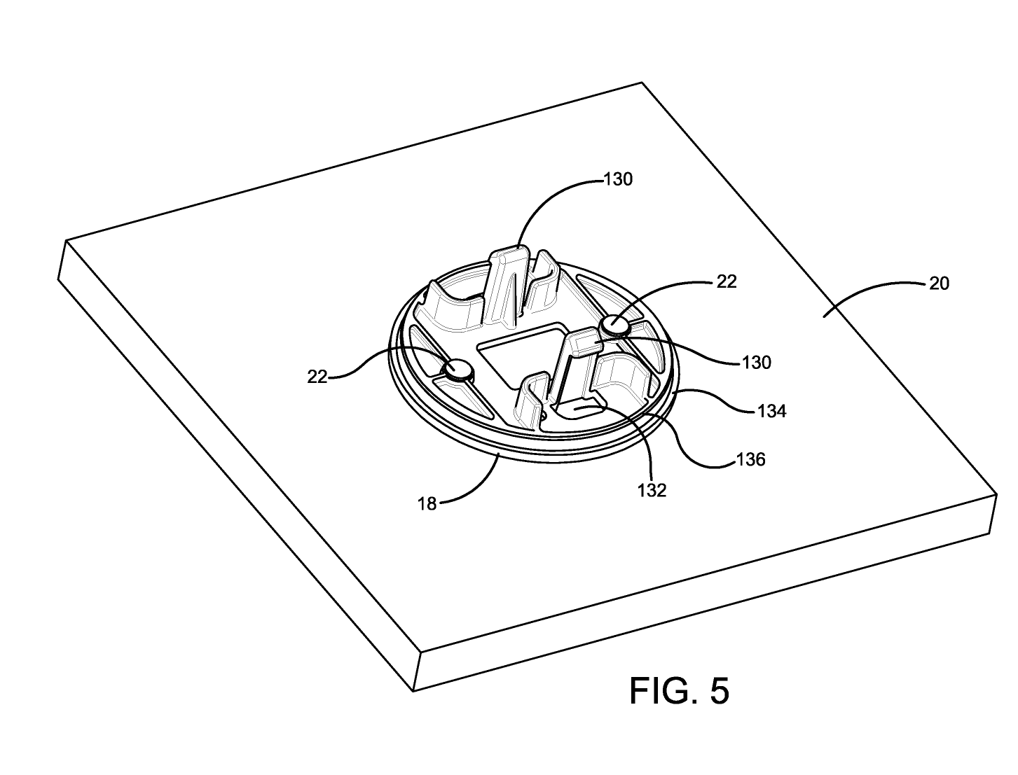

A mounting plate 18 is configured to be secured to a portion of the form 20 with connectors 22 as shown in FIGS. 4-5. Form 20 is frequently wood but also may be plastic or foam. Connectors 22 are selected to work with the material of form 20 and may be nails when form 20 is wood. Threaded connectors, rivets, and adhesive 22 also may be used to hold mounting plate 18 in place as needed.

Once mounting plate 18 is secured to form 20, body 14 is connected to mounting plate 18. The connection between body 14 and mounting plate 18 is a releasable connection because mounting plate 18 is removed after the slab is formed around body 14 and cap 12. In the exemplary configuration, body 14 is secured to mounting plate 18 with a pair of releasable mount fingers 130 that extend up inside cavity 104 and engage corresponding mounting surfaces defined by body 14. Fingers 130 may extend from body 14 and mounting surfaces may be defined by mounting plate 18. Mounting plate 18 defines an opening 132 adjacent each mounting finger 130 so that the user may insert a tool such as a screwdriver to manipulate mounting fingers 130 from an engaged position to a disengaged position when the user wishes to remove mounting plate 18 as described below. Mounting plate 18 also defines a sealing ledge 134 and an inner wall 136 which seal with the lower portion of body 14 to prevent concrete form entering cavity 104 when the slab is formed. Ledge 134 and inner wall 136 match the shape of sidewall 100 and may be sized to fit together with a tight frictional fit. The lower edge 138 of body 14 seats against ledge 134 when body 14 is secured to mounting plate 18.

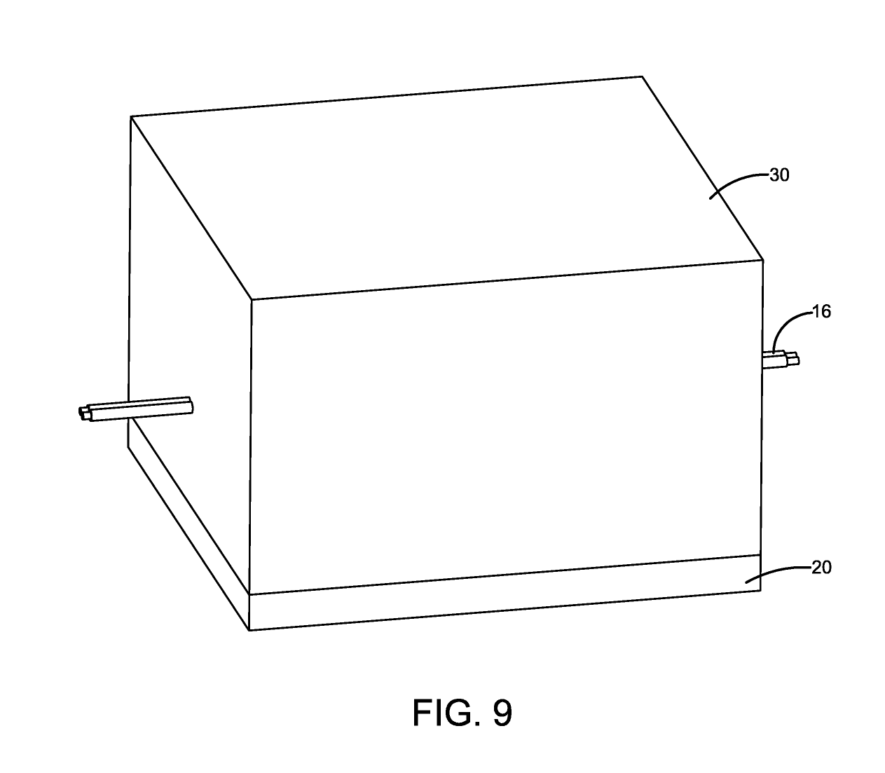

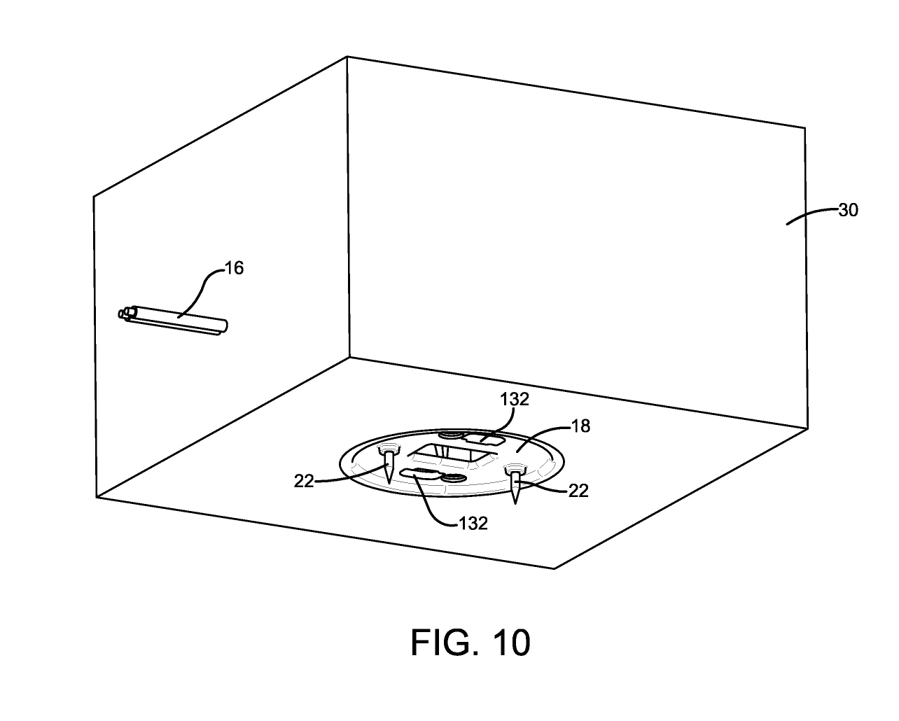

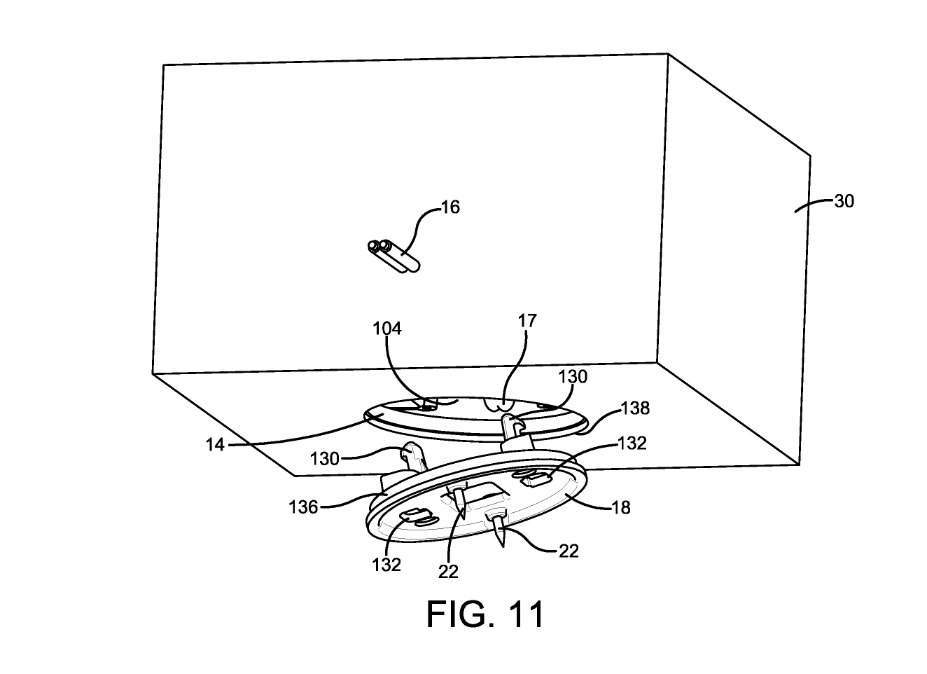

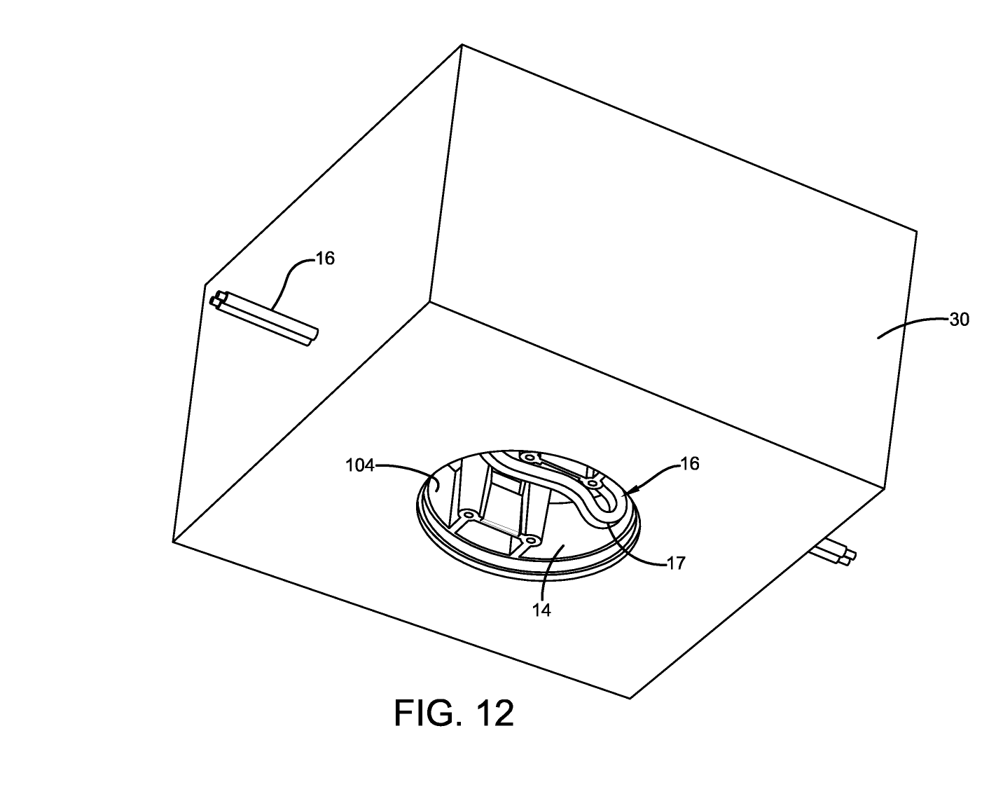

Unit 10 is installed by connecting mounting plate 18 to a section of form 20 as shown in FIG. 5. Typically, mounting plate 18 is installed at a location of form 20 that will define a downwardly-facing section of the construction component that is to be formed in form 20. This section may be a lowermost surface but also may be a downwardly-facing inner surface. Mounting plate 18 is secured with connectors 22. The combination of body 14, cap 12, and wire 16 are connected to mounting plate 18 such that they are disposed within the confines of the form and a portion of wire 16 extends out of the form. There may be rebar in the form. Concrete is poured into the form to surround body 14, cap 12, and wire 16 except the portion disposed against mounting plate 18. After the concrete cures to form a construction component 30 such as a concrete slab 30 shown in FIG. 9, the form 20 is removed to expose mounting plate 18 as shown in FIG. 10. When one is ready to install a light, mounting plate 18 is removed as shown in FIG. 11 to expose the section 17 of wire 16 disposed in body 14 as shown in FIG. 12. The user may then hang a light engine from body 14 or from a hanger attached to slab 30 with a power connector attached to section 17 of wire 16.

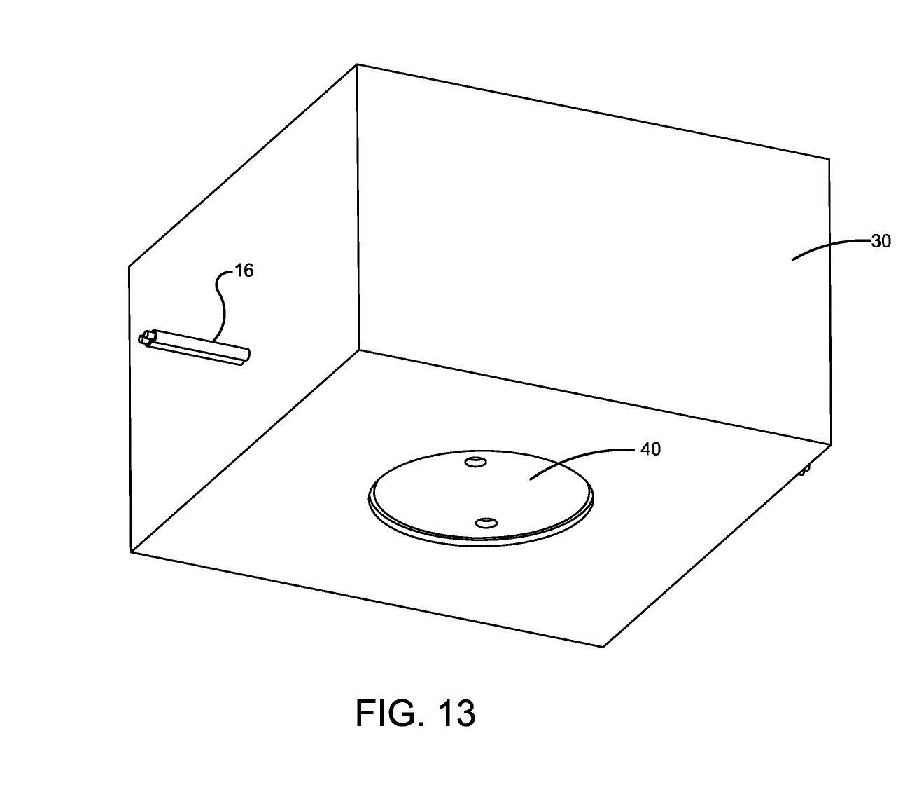

When the worker no longer needs the light engine powered by wire 16, the power supply to wire 16 is removed and a closure 40 is attached to body 14 as shown in FIG. 13. This closure 40 can be covered with drywall, a drop ceiling, or may be directly skim coated with drywall mud or plaster during the finishing of the surface of slab 30. In other embodiments, a light fixture is hung from body 14 and powered from wire 16 and a decorative closure 40 is installed. Closure 40 is connected with devices similar to mount fingers 130 or it may be connected with traditional mechanical connectors.

This system is easy to install and provides a convenient source of task lighting inside a construction project. The process of installing the fixtures and wiring is performed as the forms are assembled and there is no need to remove the system from the project when the lighting is no longer needed. These steps save costs of installing and removing electrical runs. The use of a low-voltage lighting system reduces the cost of electricity used on the project.

In the foregoing description, certain terms have been used for brevity, clearness, and understanding. No unnecessary limitations are to be implied therefrom beyond the requirement of the prior art because such terms are used for descriptive purposes and are intended to be broadly construed. Moreover, the above description and attached illustrations are an example and the invention is not limited to the exact details shown or described. Throughout the description and claims of this specification the words “comprise” and “include” as well as variations of those words, such as “comprises,” “includes,” “comprising,” and “including” are not intended to exclude additives, components, integers, or steps.

1. A lighting unit for use with a concrete slab to provide electrical power to a light; the unit comprising:
a body that defines a cavity;
a cap associated with the body; and
a mounting plate releasably connected to the body; the mounting plate closing the cavity when the plate is connected to the body; the cavity of the body being accessible when the plate is disconnected from the body.

2. The lighting unit of claim 1, wherein the mounting plate includes a connector adapted to secure the mounting plate to a form used to fabricate a concrete slab.

3. The lighting unit of claim 2, further comprising a releasable mount finger that releasably connects the mounting plate to the body.

4. The lighting unit of claim 3, wherein the releasable mount finger extends from the mounting plate.

5. The lighting unit of claim 3, wherein the mounting plate defines an opening that provides access to the releasable mount finger.

6. The lighting unit of claim 1, wherein the mounting plate includes an inner wall and a sealing ledge; the inner wall disposed inside the body when the mounting plate is connected to the body; and the body engaging the sealing ledge when the mounting plate is connected to the body.

7. The lighting unit of claim 6, wherein the inner wall frictionally engages the body when the mounting plate is connected to the body.

8. The lighting unit of claim 1, wherein the body includes a sidewall and a top wall; the top wall being disposed between the mounting plate and the cap when the mounting plate and cap are connected to the body.

9. The lighting unit of claim 8, wherein the top wall defines an opening that provides access to the cavity through the top wall.

10. The lighting unit of claim 9, wherein the opening is an elongated slot and the body includes ribs disposed substantially perpendicular to the elongated dimension of the slot.

11. The lighting unit of claim 9, wherein the body includes a wire clamp rib disposed adjacent the opening.

12. The lighting unit of claim 11, further comprising a wire disposed between the cap and the body with a section of the wire disposed in the cavity.

13. The lighting unit of claim 12, wherein the wire engages the wire clamp rib.

14. The lighting unit of claim 1, further comprising a locking finger and locking surface that cooperate to secure the cap to the body.

15. The lighting unit of claim 14, wherein the locking finger and locking surface cooperate in a one-way snap fit connection.

16. The lighting unit of claim 1, wherein the body defines a notch and the cap includes an alignment rib that is disposed in the notch when the cap is connected to the body.

17. A method of supplying electrical power to a light fixture through a concrete slab; the method comprising the steps of:
providing a form used to fabricate a concrete slab;
connecting a lighting unit to the form wherein the lighting unit includes an electrical wire having a first portion disposed within the lighting unit and a second portion adapted to receive electrical power;
fabricating the concrete slab within the form around the lighting unit;
separating the form from the concrete slab to expose a portion of the lighting unit;
removing a portion of the lighting unit to provide access to the first portion of the electrical wire; and
supplying electrical power to the second portion of the electrical wire.

18. The method of claim 17, further comprising the step of connecting a closure member to the electrical unit after the user is finished with the electrical unit.

19. The method of claim 17, wherein the connecting step includes the steps of:
securing a mounting plate to the form; and
connecting a body to the mounting plate after the mounting plate is secured to the form.

20. The method of claim 19, further comprising the step of placing the first portion of the electrical wire within the body before the body is connected to the mounting plate.
